(19) United States
(12) Patent Application Publication
(10) Pub. No.: US 2023/0076793 A1
(43) Pub. Date: Mar. 9, 2023

(54) ELECTRONIC PARKING BRAKE SYSTEM AND CONTROL METHOD THEREOF

(71) Applicant: MANDO CORPORATION, Pyeongtaek-si (KR)

(72) Inventor: Jihwan KIM, Suwon-si (KR)

(73) Assignee: MANDO CORPORATION, Pyeongtaek-si (KR)

(21) Appl. No.: 17/902,395

(22) Filed: Sep. 2, 2022

(30) Foreign Application Priority Data
Sep. 6, 2021 (KR) 10-2021-0118589

(51) Int. Cl. F16D 65/18

(52) U.S. Cl. CPC F16D 65/18; F16D 2121/24

(57) ABSTRACT

An electronic parking brake system including: an electronic parking brake (EPB) including a piston that moves by a hydraulic pressure to press brake pads onto a brake disc, a cylinder in which the piston is provided movably forward and backward, and an EPB actuator that moves the piston by a motor to press the brake pads onto the brake disc; a pressure sensor configured to detect a hydraulic pressure of the cylinder; an electronic stability control (ESC) actuator configured to generate and supply a hydraulic pressure to the cylinder; and a controller configured to control the EPB actuator and the ESC actuator, wherein the controller is configured to detect an actual hydraulic pressure of the cylinder through the pressure sensor in an EPB disengagement, and when the detected actual hydraulic pressure is higher than a required hydraulic pressure, control the EPB actuator to start an EPB disengagement control.

### CROSS REFERENCE TO RELATED APPLICATION

This application is based on and claims priority under 35 U.S.C. §119 to Korean Patent Application No. 10-2021-0118589, filed on Sep. 6, 2021 in the Korean Intellectual Property Office, the disclosure of which is incorporated herein by reference.

### BACKGROUND

### 1. Technical Field

The disclosure relates to an electronic parking brake system that engages or disengages an electronic parking brake and a control method thereof.

### 2. Background Art

In general, an electronic parking brake (EPB) generates a clamping force through a Motor-on-Caliper (MoC) actuator using a motor. When the motor rotates a spindle member to move a nut member forward, the nut member pushes a piston inside a caliper, and thus brake pads come into contact with a brake disc and clamping force may be generated.

Also, in the EPB, instead of operating a MoC actuator, by moving a piston by a hydraulic pressure provided to a cylinder inside a caliper, brake pads may be brought into contact with the brake disc to generate a clamping force.

As such, the EPB may be engaged through driving a motor or a hydraulic pressure.

Accordingly, in the EPB, a degree to which brake pads press a brake disc varies depending on whether hydraulic pressure is applied and a magnitude of hydraulic pressure, causing a difference in final clamping force or a difference in the amount of change in clamping force.

When an error caused by the above difference is not controlled, failures such as engagement is not released only with a torque of motor itself due to excessive engagement, friction occurs even after disengagement due to control logic malfunction, and the like, may occur.

### SUMMARY

An aspect of the disclosure provides an electronic parking brake system and a control method thereof that may perform disengagement of an electronic parking brake more accurately and reliably.

Additional aspects of the disclosure will be set forth in part in the description which follows and, in part, will be obvious from the description, or may be learned by practice of the disclosure.

According to an aspect of the disclosure, there is provided an electronic parking brake system, including: an electronic parking brake (EPB) including a piston that moves by a hydraulic pressure to press brake pads onto a brake disc, a cylinder in which the piston is provided movably forward and backward, and an EPB actuator that moves the piston by a motor to press the brake pads onto the brake disc; a pressure sensor configured to detect a hydraulic pressure of the cylinder; an electronic stability control (ESC) actuator configured to generate and supply a hydraulic pressure to the cylinder; and a controller configured to control the EPB actuator and the ESC actuator, wherein the controller is configured to detect an actual hydraulic pressure of the cylinder through the pressure sensor in an EPB disengagement, and when the detected actual hydraulic pressure is higher than a required hydraulic pressure, control the EPB actuator to start an EPB disengagement control.

When the detected actual hydraulic pressure is lower than the required hydraulic pressure, the controller is configured to supply the hydraulic pressure through the ESC actuator, until the detected actual hydraulic pressure reaches the required hydraulic pressure.

The controller is configured to identify the required hydraulic pressure according to a hydraulic pressure of the cylinder at a time of EPB engagement.

The electronic parking brake system further includes a memory in which a hydraulic pressure of the cylinder at the time of EPB engagement is stored.

In an EPB engagement, the controller is configured to detect the hydraulic pressure of the cylinder at the time of EPB engagement through the pressure sensor, and store the detected hydraulic pressure of the cylinder in the memory.

In the EPB engagement, the controller is configured to store the detected hydraulic pressure of the cylinder in the memory, when the detected hydraulic pressure of the cylinder is higher than a preset hydraulic pressure.

In the EPB engagement, when the detected hydraulic pressure of the cylinder is lower than a preset hydraulic pressure, the controller is configured to supply the hydraulic pressure through the ESC actuator, until the detected hydraulic pressure of the cylinder reaches the preset hydraulic pressure.

According to another aspect of the disclosure, there is provided a control method of an electronic parking brake system including an EPB having a piston that moves by a hydraulic pressure to press brake pads onto a brake disc, a cylinder in which the piston is provided movably forward and backward, and an EPB actuator that moves the piston by a motor to press the brake pads onto the brake disc, the control method including: detecting an actual hydraulic pressure of the cylinder in an EPB disengagement; and when the detected actual hydraulic pressure is higher than a required hydraulic pressure, controlling the EPB actuator to start an EPB disengagement control.

When the detected actual hydraulic pressure is lower than the required hydraulic pressure, the starting of the EPB disengagement control includes supplying the hydraulic pressure through an ESC actuator, until the detected actual hydraulic pressure reaches the required hydraulic pressure.

The starting of the EPB disengagement control includes identifying the required hydraulic pressure according to a hydraulic pressure of the cylinder at a time of EPB engagement.

The control method further includes, in an EPB engagement, detecting the hydraulic pressure of the cylinder at the time of EPB engagement, and storing the detected hydraulic pressure of the cylinder in a memory.

The storing of the detected hydraulic pressure of the cylinder in the memory includes storing the detected hydraulic pressure of the cylinder in the memory, when the detected hydraulic pressure of the cylinder is higher than a preset hydraulic pressure in the EPB engagement.

When the detected hydraulic pressure of the cylinder is lower than a preset hydraulic pressure in the EPB engagement, the storing of the detected hydraulic pressure of the cylinder in the memory includes supplying the hydraulic pressure through an ESC actuator, until the detected hydraulic pressure of the cylinder reaches the preset hydraulic pressure.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 illustrates an electronic parking brake applied to an electronic parking brake system according to an embodiment;

FIG. 2 is a schematic block diagram of an electronic parking brake system according to an embodiment;

FIG. 3 is a flowchart illustrating an electronic parking brake engagement in an electronic parking brake system according to an embodiment;

FIG. 4 illustrates an operation of an electronic parking brake engagement in an electronic parking brake system according to an embodiment;

FIG. 5 is a flowchart illustrating an electronic parking brake disengagement in an electronic parking brake system according to an embodiment; and

FIG. 6 illustrates an operation of an electronic parking brake disengagement in an electronic parking brake system according to an embodiment.

### DETAILED DESCRIPTION

Like reference numerals throughout the specification denote like elements. Also, this specification does not describe all the elements according to embodiments of the disclosure, and descriptions well-known in the art to which the disclosure pertains or overlapped portions are omitted. The terms such as “~part”, “~member”, “~module”, “~block”, and the like may refer to at least one process processed by at least one hardware or software. According to embodiments, a plurality of “~part”, “~member”,“~module”, “~block” may be embodied as a single element, or a single of “~part”, “~member”,“~module”, “~block” may include a plurality of elements.

It will be understood that when an element is referred to as being “connected” to another element, it can be directly or indirectly connected to the other element, wherein the indirect connection includes “connection” via a wireless communication network.

It will be understood that the term “include” when used in this specification, specifies the presence of stated features, integers, steps, operations, elements, and/or components, but do not preclude the presence or addition of one or more other features, integers, steps, operations, elements, components, and/or groups thereof.

It will be understood that when it is stated in this specification that a member is located “on” another member, not only a member may be in contact with another member, but also still another member may be present between the two members.

It will be understood that, although the terms first, second, etc. may be used herein to describe various elements, these elements should not be limited by these terms. It is to be understood that the singular forms are intended to include the plural forms as well, unless the context clearly dictates otherwise.

Reference numerals used for method steps are just used for convenience of explanation, but not to limit an order of the steps. Thus, unless the context clearly dictates otherwise, the written order may be practiced otherwise.

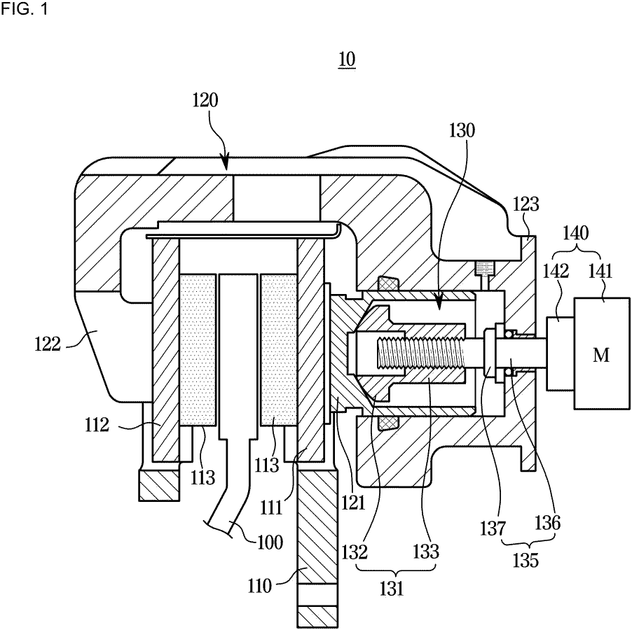

FIG. 1 illustrates an electronic parking brake applied to an electronic parking brake system according to an embodiment.

Referring to FIG. 1, an electronic parking brake (EPB) 10 may include a carrier 110 on which a pair of pad plates 111 and 112 are installed movably in forward and backward directions to press a brake disc 100 that rotates with a wheel of a vehicle, a caliper housing 120 slidably installed on the carrier 110 and including a cylinder 123 in which a piston 121 is movably installed in forward and backward directions by braking hydraulic pressure, a power conversion unit 130 provided to press the piston 121, and a motor actuator 140 provided to deliver a rotational force to the power conversion unit 130 using the motor M.

The pair of pad plates 111 and 112 are divided into an inner pad plate 111 disposed to be in contact with the piston 121 and an outer pad plate 112 disposed to be in contact with a finger part 122 of the caliper housing 120. The pair of pad plates 111 and 112 are installed on the carrier 110 fixed to a vehicle body so that the pair of pad plates 111 and 112 may move toward both sides of the brake disc 100. Also, brake pads 113 are attached to one surface of each of the pair of pad plates 111 and 112 that face the brake disc 100.

The caliper housing 120 is slidably installed on the carrier 110. More specifically, the power conversion unit 130 is installed at a rear of the caliper housing 120, and the caliper housing 120 includes the cylinder 123 in which the piston 121 is movably installed in forward and backward directions and the finger part 122 bent in a lower direction to operate the outer pad plate 112. The finger part 122 and the cylinder 123 are integrally formed.

The piston 121 is provided in a cylindrical shape to have a u-shaped inside like a cup, and slidably inserted inside the cylinder 123. The piston 121 presses the inner pad plate 111 toward the brake disc 100 by an axial force of the power conversion unit 130 that receives the rotational force of the motor actuator 140. Accordingly, when the axial force of the power conversion unit 130 is applied, the piston 121 moves toward the inner pad plate 111, thereby pressing the inner pad plate 111. The caliper housing 120 operates in an opposite direction to the piston 121 by a reaction force, and thus the finger part 122 presses the outer pad plate 112 to the brake disc 100 side. Accordingly, braking may be performed.

An EPB actuator 130 and 140 may include the power conversion unit 130 and the motor actuator 140.

The power conversion unit 130 may receive the rotational force form the motor actuator 140 and function to press the piston 121 to the inner pad plate 111 side.

The power conversion unit 130 may include a nut member 131, disposed inside the piston 121 to be in contact with the piston 121, and a spindle member 135 screwed to the nut member 131.

The nut member 131 is disposed inside the piston 121 in a state where rotation thereof is limited, and is screwed to the spindle member 135.

The nut member 131 may include a head portion 132 provided to be in contact with the piston 121, and an engagement portion 133 extending from the head portion 132 and in which a female screw thread is formed on an inner circumferential surface thereof in order to be screwed to the spindle member 135.

The nut member 131 moves forward or backward depending on a rotation direction of the spindle member 135, and may function to press the piston 121 or release the pressure on the piston 121. In this instance, the forward direction may be a movement direction in which the nut member 131 approaches the piston 121. The backward direction may be a movement direction in which the nut member 131 is away from the piston 121. In addition, the forward direction may be a movement direction in which the piston 121 approaches the brake pads 113. The backward direction may be a movement direction in which the piston 121 is away from the brake pads 113.

The spindle member 135 may include a shaft portion 136, which passes through a rear portion of the caliper housing 120 and rotates by receiving the rotational force of the motor actuator 140, and a flange portion 137 radially extending from the shaft portion 136. The shaft portion 136 may have one side which is rotatably installed and passes through a rear side of the cylinder 123, and the other side disposed inside the piston 121. In this instance, the one side of the shaft portion 136 that passes through the cylinder 123 is connected to an output shaft of a reducer 142 to receive the rotational force of the motor actuator 140.

The motor actuator 140 may include a motor 141 and the reducer 142.

The motor 141 moves the nut member 131 forward or backward by rotating the spindle member 135, thereby pressing the piston 121 or releasing the pressure on the piston 121.

The reducer 142 may be provided between an output side of the motor 141 and the spindle member 135.

Through the above configuration, when the EPB 10 is engaged, the EPB 10 may rotate the spindle member 135 in one direction using the motor actuator 140, thereby moving the nut member 131 and pressing the piston 121. The piston 121 pressed by the movement of the nut member 131 presses the inner pad plate 111, and thus the brake pads 113 come into close contact with the brake disc 100, thereby may perform an engagement operation that generates a clamping force.

Also, when parking is released, the EPB 10 may rotate the spindle member 135 in an opposite direction using the motor actuator 140, thereby moving the nut member 131 pressed by the piston 121 backward. The pressure on the piston 121 may be released by the backward movement of the nut member 131. Due to the release of the pressure on the piston 121, the brake pads 113 may be spaced apart from the brake disc 100, thereby may perform a disengagement operation that releases the generated clamping force.

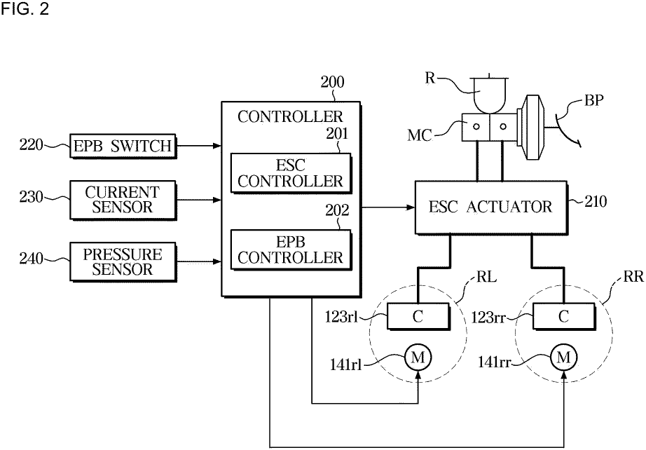

FIG. 2 is a schematic block diagram of an electronic parking brake system according to an embodiment.

Referring to FIG. 2, the EPB 10 is provided at left and right rear wheels RL and RR of a vehicle.

The electronic parking brake system may include a controller 200, an electronic stability control (ESC) actuator 210, an EPB switch 220, a current sensor 230 and a pressure sensor 240.

The controller 200 may be referred to as an electronic control unit (ECU).

The controller 200 may include a processor and a memory. The processor may control overall operations of the electronic parking brake system. The memory may store a program for processing or control of the processor and various data for operating the electronic parking brake system. The memory may include a volatile memory such as a static random access memory (S-RAM) and dynamic random access memory (D-RAM), and a non-volatile memory such as a flash memory, a read only memory (ROM), an erasable programmable read only memory (EPROM), and the like.

The controller 200 may include an ESC controller 201 that controls operations of the ESC actuator 210 and an EPB controller 202 that controls operations of the motor 141 of the EPB 10. The ESC controller 201 and the EPB controller 202 may be a single integrated ECU or separate ECUs connected through a communication interface.

The ESC actuator 210 may supply a brake hydraulic pressure to cylinders 123rl and 123rr of the EPBs 10rl and 10rr of the left and right rear wheels RL and RR in order to brake the left and right rear wheels RL and RR.

The ESC actuator 210 is connected to a master cylinder MC coupled to a reservoir R that stores a brake oil through a brake pipe.

The ESC actuator 210 is connected to the cylinder 123rl of the EPB 10rl of the left rear wheel RL and the cylinder 123rr of the EPB 10rr of the right rear wheel RR through the brake pipe.

The ESC actuator 210 may include an ON/OFF valve for adjusting the brake hydraulic pressure supplied to the cylinders 123rl and 123rr during braking control, and a hydraulic circuit for supplying a brake hydraulic pressure generated by the master cylinder MC to the cylinders 123rl and 123rr, or for generating a brake hydraulic pressure using a hydraulic pressure generator such as a motor pump, a hydraulic piston, etc., and supplying the generated brake hydraulic pressure to the cylinders 123rl and 123rr.

The ESC actuator 210 described above may supply the cylinders 123rl and 123rr with the brake hydraulic pressure, generated in the master cylinder MC by an operation of the brake pedal BP, and actuate the ON/OFF valve as required. Alternatively, the ESC actuator 210 may supply the cylinders 123rl and 123rr with the brake hydraulic pressure, generated by the hydraulic circuit, and actuate the ON/OFF valve as required. Accordingly, a braking force required for wheels may be generated. The brake hydraulic pressure supplied to the cylinders 123rl and 123rr presses the piston 121, thereby bringing the brake pads 113 into close contact with the brake disc 100. Accordingly, a braking force may be generated on the left and right rear wheels RL and RR.

The EPB switch 220 is for receiving a driver’s operation intention with respect to the EPB 10, and may be provided around a driver’s seat of the vehicle.

The EPB switch 220 is turned on or off by a driver.

When the EPB switch 220 is on, a signal corresponding to a parking operation command, i.e., an EPB engagement command, is transmitted to the controller 200. When the EPB switch 220 is off, a signal corresponding to a parking release command, i.e., an EPB disengagement command, is transmitted to the controller 200.

The controller 200 may perform an EPB engagement mode for an engagement of the EPB 10 or an EPB disengagement mode, by an operation signal of the EPB switch 220 manipulated by the driver, or an operation signal generated by a program related to an operation of the EPB 10.

In the EPB engagement mode, the controller 200 rotates the motors 141rl and 141rr in one direction, thereby moving the nut member 131 in the forward direction and pressing the piston 121 to bring the brake pads 113 into close contact with the brake disc 100. Accordingly, an EPB engagement that generates a clamping force by bringing the brake pads 113 into close contact with the brake disc 100 may be performed.

In the EPB disengagement mode, the controller 200 rotates the motors 141rl and 141rr in opposite direction, thereby moving the nut member 131 in the backward direction and releasing the pressure on the piston 121 to separate the brake pads 113 from the brake disc 100. Accordingly, an EPB disengagement that releases the generated clamping force may be performed.

The current sensor 230 detects a current flowing through the motors 141rl and 141rr of the EPBs 10rl and 10rr. The current sensor 230 may detect a motor current flowing through the motors using a shunt resistance or a hall sensor. In addition to the shunt resistance or hall sensor, various methods may be applied to the current sensor 230 for detecting the motor current.

In the EPB engagement mode, the controller 200 may rotate the motors 141rl and 141rr in one direction until current values of the motors 141rl and 141rr reach a target current value corresponding to a clamping force required for parking, and then, when reaching the target current value, stop the motors 141rl and 141rr to end an EPB engagement operation.

In the EPB disengagement mode, the controller 200 may rotate the motors 141rl and 141rr in opposite direction, and then, when a preset time elapses, stop the motors 141rl and 141rr to end the EPB disengagement.

The pressure sensor 240 detects hydraulic pressure of the cylinders 123rl and 123rr of the EPBs 10rl and 10rr. The pressure sensor 240 may detect the hydraulic pressure supplied to the cylinders 123rl and 123rr from the master cylinder MC by an operation of the brake pedal BP, or the hydraulic pressure supplied to the cylinders 123rl and 123rr from the hydraulic pressure generator such as a motor pump, a hydraulic piston, etc.

The pressure sensor 240 transmits the detected cylinder hydraulic pressure to the controller 200.

The controller 200 recognizes the hydraulic pressure of the cylinders 123rl and 123rr of the EPBs 10rl and 10rr, based on information about the cylinder hydraulic pressure provided from the pressure sensor 240.

Before the EPB actuator 130 and 140 are operated, the controller 200 may supply hydraulic pressure to the cylinders 123rl and 123rr of the EPBs 10rl and 10rr through an ESC cooperative control by the ESC actuator 210.

When the hydraulic pressure of the cylinders 123rl and 123rr is required to be increased, the controller 200 may generate the brake hydraulic pressure using the hydraulic pressure generator of the ESC actuator 210, such as a motor pump, a hydraulic piston, etc., and supply the generated brake hydraulic pressure to the cylinders 123rl and 123rr.

As described above, conventionally, when the EPB 10 is engaged with an excessive clamping force due to excessive hydraulic pressure application, etc., the EPB 10 may not be disengaged properly due to insufficient torque of the EPB actuator 130 and 140.

For example, in a state where a large hydraulic pressure is supplied to the cylinder 123 of the EPB 10 since a driver depresses the brake pedal BP strongly, when releasing the hydraulic pressure by taking driver’s foot off the brake pedal BP after operating the EPB actuator 130 and 140, the EPB actuator 130 and 140 and the piston 121 to be restored after being pressed by the hydraulic pressure are in close contact with each other, and constituent components of the EPB actuator 130 and 140 are engaged with each other tightly. Accordingly, the EPB 10 may be engaged with a greater clamping force than when the engagement is performed only with the EPB actuator 130 and 140.

As such, when parking is released in the state where the EPB 10 is engaged with a great clamping force, a large torque is required to initially drive the EPB actuator 130 and 140. Accordingly, disengagement may not be performed only by the torque of the motor itself, or remaining clamping force remains even after disengagement because the disengagement is performed incompletely.

According to the disclosure, because a magnitude of hydraulic pressure affects a movement (current, voltage, torque, clamping force, etc.) of the EPB actuator when the EPB is engaged and disengaged, and because a hydraulic pressure varies for each operation depending on various factors such as a driver, vehicle, road inclination, and the like, hydraulic pressure is generalized through a hydraulic cooperative control. First, in the EPB engagement, when a hydraulic pressure greater than or equal to a predetermined level is required to achieve a desired braking force, and when a magnitude of hydraulic pressure at the time of receiving an EPB engagement command is less than a required hydraulic pressure, requesting the hydraulic cooperative control to reach the required hydraulic pressure is the same as a conventional art. When a hydraulic pressure at a corresponding point in time is greater than the required hydraulic pressure, an additional hydraulic cooperative control request is not required, and thus an EPB engagement control may be performed. In this instance, according to the disclosure, an actually supplied hydraulic pressure is required to be stored in the memory for use in the EPB disengagement.

According to the disclosure, in the EPB disengagement, a magnitude of the hydraulic pressure stored in the memory in the EPB engagement is identified and a hydraulic pressure required in the EPB disengagement is set according to the identified magnitude of the hydraulic pressure. As in the EPB engagement, when a hydraulic pressure less than the required hydraulic pressure is being supplied at a corresponding point in time, a hydraulic pressure is supplied to reach the required hydraulic pressure through the hydraulic cooperative control request, and then an EPB disengagement control is performed.

According to the disclosure, in the EPB engagement and the EPB disengagement, a hydraulic pressure is consistently supplied, thereby minimizing a change between the EPB engagement and the EPB disengagement. That is, according to the disclosure, in the EPB disengagement, a hydraulic pressure similar to the hydraulic pressure supplied when the EPB is engaged may be supplied before operating the EPB actuator 130 and 140. Accordingly, after returning a degree of contact between the piston 121 and the EPB actuator 130 and 140 and a degree of engagement among the constituent components of the EPB actuator 130 and 140 to normal ranges, an EPB disengagement operation is performed.

Therefore, according to the disclosure, in the EPB disengagement, a required torque of the EPB actuator 130 and 140 may be reduced by supplying a hydraulic pressure, and thus failures, such as disengagement may not be performed only by a torque of the motor itself or remaining clamping force remains even after disengagement because the disengagement is performed incompletely, may be prevented. Thus, the EPB disengagement may be performed more accurately and reliably.

According to the disclosure, an effect caused by a change in hydraulic pressure in the EPB disengagement may be eliminated through generalization for supplying a hydraulic pressure to a specific level or a single hydraulic pressure in the EPB engagement and the EPB disengagement. Therefore, an erroneous control such as incomplete or excessive EPB disengagement, and failures such as excessive friction, etc., due to the erroneous control may be prevented.

According to the disclosure, EPB disengagement performed by excessive torque of the EPB actuator 130 and 140 may be prevented, thereby increasing a product lifespan.

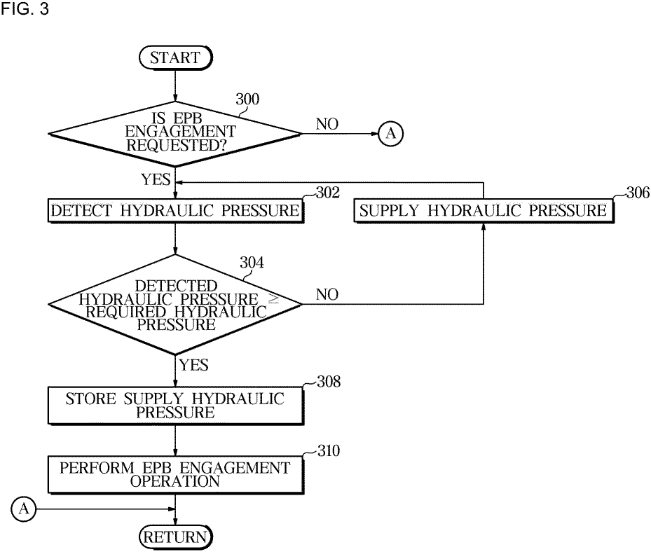

FIG. 3 is a flowchart illustrating an EPB engagement in an electronic parking brake system according to an embodiment.

Referring to FIG. 3, the controller 200 identifies whether an EPB engagement is requested (300).

When the EPB engagement is requested, the controller 200 detects a hydraulic pressure of the cylinder 123 of the EPB 10 through the pressure sensor 240 (302).

The controller 200 identifies whether the detected hydraulic pressure is greater than or equal to a required hydraulic pressure by comparing the detected hydraulic pressure with the required hydraulic pressure (304). The required hydraulic pressure may be a preset hydraulic pressure. For example, the required hydraulic pressure may be a minimum pressure that may generate a clamping force capable of stopping a corresponding vehicle wheel in a state where the EPB actuator 130 and 140 is not operated in an EPB engagement. The required hydraulic pressure may vary depending on a vehicle state such as an inclination of vehicle.

When the detected hydraulic pressure is less than the required hydraulic pressure as a result of identification in operation 304, the controller 200 generates a hydraulic pressure through the ESC actuator 210 and supplies the hydraulic pressure to the cylinder 123 of the EPB 10 (306).

Meanwhile, when the detected hydraulic pressure is greater than or equal to the required hydraulic pressure as a result of identification in operation 304, the controller 200 stores a current hydraulic pressure supplied to the cylinder 123 of the EPB 10 in the memory (308).

Afterwards, the controller 200 performs an EPB engagement operation (310). The controller 200 rotates the motor 141 in one direction, and then when a motor current detected through the current sensor 230 reaches a target current corresponding to EPB engagement, identifies that the EPB engagement is complete and ends the EPB engagement operation.

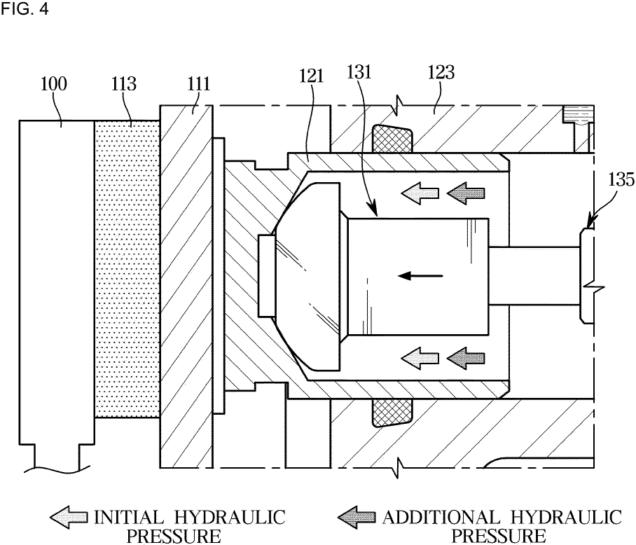

FIG. 4 illustrates an operation of an EPB engagement in an electronic parking brake system according to an embodiment.

Referring to FIG. 4, in an EPB engagement, before driving the motor 141, when an initial hydraulic pressure which is a current hydraulic pressure of the cylinder 123 is lower than a required hydraulic pressure, the controller 200 supplies an additional hydraulic pressure to the cylinder 123 through the ESC actuator 210 so that the cylinder hydraulic pressure reaches the required hydraulic pressure.

When the cylinder hydraulic pressure reaches the required hydraulic pressure, the controller 200 drives the motor 141 to move the nut member 131 forward. The piston 121 is pressed by the movement of the nut member 131, and thus the brake pads 113 come into contact with the brake disc 100, thereby generating a clamping force required for parking. Afterwards, the controller 200 stops the motor 141, thereby allowing the nut member 131 to be maintained in an engagement position when the piston 121 is pressed maximally.

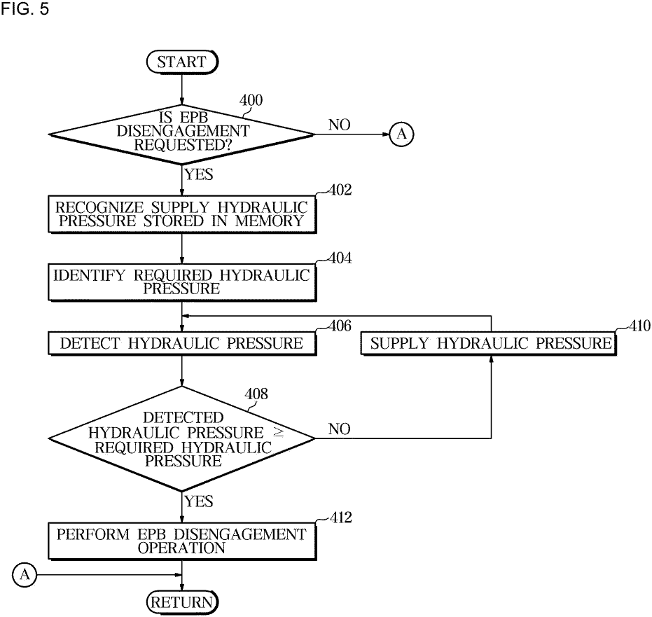

FIG. 5 is a flowchart illustrating an EPB disengagement in an electronic parking brake system according to an embodiment.

Referring to FIG. 5, the controller 200 identifies whether an EPB disengagement is requested (400).

When the EPB disengagement is requested, the controller 200 recognizes a supply hydraulic pressure stored in the memory (402). The supply hydraulic pressure stored in the memory is a hydraulic pressure supplied to the cylinder 123 in an EPB engagement, is greater than or equal to a required hydraulic pressure, and is stored in the memory in the EPB engagement.

The controller 200 may identify the required hydraulic pressure according to the recognized supply hydraulic pressure (404). In this instance, the required hydraulic pressure may be the recognized supply hydraulic pressure or be higher than the recognized supply hydraulic pressure by a predetermined level. Also, the required hydraulic pressure may be a preset hydraulic pressure.

The controller 200 detects a hydraulic pressure of the cylinder 123 of the EPB 10 through the pressure sensor 240 (406).

The controller 200 identifies whether the detected hydraulic pressure is greater than or equal to the required hydraulic pressure by comparing the detected hydraulic pressure with the required hydraulic pressure (408).

When the detected hydraulic pressure is less than the required hydraulic pressure as a result of identification in operation 408, the controller 200 generates a hydraulic pressure through the ESC actuator 210 and supplies the hydraulic pressure to the cylinder 123 of the EPB 10 (410).

Meanwhile, when the detected hydraulic pressure is greater than or equal to the required hydraulic pressure as a result of identification in operation 408, the controller 200 performs an EPB disengagement operation (412). The controller 200 rotates the motor 141 in opposite direction, and then, when a preset time elapses after a motor current detected through the current sensor 230 reaches a target current corresponding to the EPB disengagement, identifies that the EPB disengagement is complete and ends the EPB disengagement operation. In this instance, the hydraulic pressure of the cylinder 123 may be released after initially driving the motor 141 due to the start of the EPB disengagement operation or after completing the EPB disengagement.

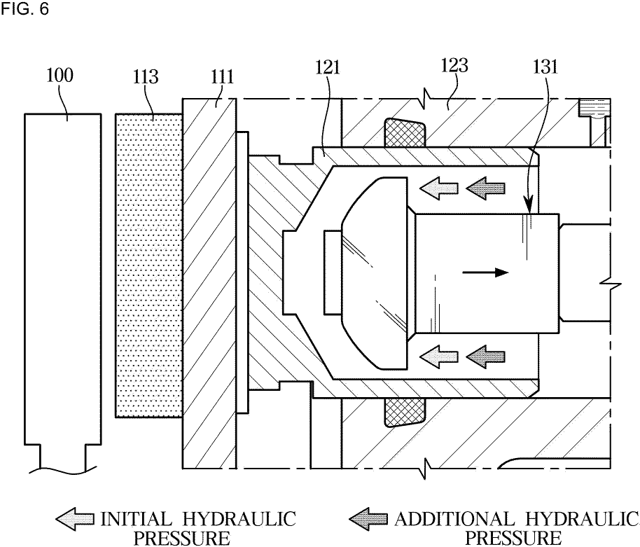

FIG. 6 illustrates an operation of an EPB disengagement in an electronic parking brake system according to an embodiment.

Referring to FIG. 6, in an EPB disengagement, before driving the motor 141, when an initial hydraulic pressure which is a current hydraulic pressure of the cylinder 123 is lower than a required hydraulic pressure according to a supply hydraulic pressure stored in the memory, the controller 200 supplies an additional hydraulic pressure to the cylinder 123 through the ESC actuator 210 so that the cylinder hydraulic pressure reaches the required hydraulic pressure.

When the cylinder hydraulic pressure reaches the required hydraulic pressure, the controller 200 drives the motor 141 to move the nut member 131 backward for the EPB disengagement. In this instance, the hydraulic pressure of the cylinder 123 may be released after initially driving the motor 141 or after completing the EPB disengagement.

As such, according to the disclosure, in the EPB disengagement, a hydraulic pressure similar to a hydraulic pressure supplied when an EPB is engaged may be supplied before operating the EPB actuator. Accordingly, after returning a degree of contact between the piston 121 and the EPB actuator 130 and 140 and a degree of engagement among the constituent components of the EPB actuator 130 and 140 to normal ranges, an EPB disengagement operation is performed. Therefore, according to the disclosure, in the EPB disengagement, a required torque of the EPB actuator 130 and 140 may be reduced by supplying a hydraulic pressure, and thus the EPB disengagement may be performed more accurately and reliably.

As is apparent from the above, according to the embodiments of the disclosure, the electronic parking brake system and the control method thereof can perform disengagement of an electronic parking brake more accurately and reliably.

Meanwhile, the aforementioned controller and/or its constituent components may include at least one processor/microprocessor(s) combined with a computer-readable recording medium storing a computer-readable code/algorithm/software. The processor/microprocessor(s) may execute the computer-readable code/algorithm/software stored in the computer-readable recording medium to perform the above-descried functions, operations, steps, and the like.

The aforementioned controller and/or its constituent components may further include a memory implemented as a non-transitory computer-readable recording medium or transitory computer-readable recording medium. The memory may be controlled by the aforementioned controller and/or its constituent components and configured to store data, transmitted to or received from the aforementioned controller and/or its constituent components, or data processed or to be processed by the aforementioned controller and/or its constituent components.

The disclosed embodiment may be implemented as the computer-readable code/algorithm/software in the computer-readable recording medium. The computer-readable recording medium may be a non-transitory computer-readable recording medium such as a data storage device capable of storing data readable by the processor/microprocessor(s). For example, the computer-readable recording medium may be a hard disk drive (HDD), a solid state drive (SDD), a silicon disk drive (SDD), a read only memory (ROM), a compact disc read only memory (CD-ROM), a magnetic tape, a floppy disk, an optical recording medium, and the like.

What is claimed is:

1. An electronic parking brake system, comprising:
an electronic parking brake (EPB) comprising a piston that moves by a hydraulic pressure to press brake pads onto a brake disc, a cylinder in which the piston is provided movably forward and backward, and an EPB actuator that moves the piston by a motor to press the brake pads onto the brake disc;
a pressure sensor configured to detect a hydraulic pressure of the cylinder;
an electronic stability control (ESC) actuator configured to generate and supply a hydraulic pressure to the cylinder; and
a controller configured to control the EPB actuator and the ESC actuator,
wherein the controller is configured to detect an actual hydraulic pressure of the cylinder through the pressure sensor in an EPB disengagement, and when the detected actual hydraulic pressure is higher than a required hydraulic pressure, control the EPB actuator to start an EPB disengagement control.

2. The electronic parking brake system of claim 1, wherein, when the detected actual hydraulic pressure is lower than the required hydraulic pressure, the controller is configured to supply the hydraulic pressure through the ESC actuator, until the detected actual hydraulic pressure reaches the required hydraulic pressure.

3. The electronic parking brake system of claim 1, wherein the controller is configured to identify the required hydraulic pressure according to a hydraulic pressure of the cylinder at a time of EPB engagement.

4. The electronic parking brake system of claim 2, further comprising:
a memory in which a hydraulic pressure of the cylinder at the time of EPB engagement is stored.

5. The electronic parking brake system of claim 4, wherein, in an EPB engagement, the controller is configured to detect the hydraulic pressure of the cylinder at the time of EPB engagement through the pressure sensor, and store the detected hydraulic pressure of the cylinder in the memory.

6. The electronic parking brake system of claim 5, wherein, in the EPB engagement, the controller is configured to store the detected hydraulic pressure of the cylinder in the memory, when the detected hydraulic pressure of the cylinder is higher than a preset hydraulic pressure.

7. The electronic parking brake system of claim 5, wherein, in the EPB engagement, when the detected hydraulic pressure of the cylinder is lower than a preset hydraulic pressure, the controller is configured to supply the hydraulic pressure through the ESC actuator, until the detected hydraulic pressure of the cylinder reaches the preset hydraulic pressure.

8. A control method of an electronic parking brake system comprising an EPB having a piston that moves by a hydraulic pressure to press brake pads onto a brake disc, a cylinder in which the piston is provided movably forward and backward, and an EPB actuator that moves the piston by a motor to press the brake pads onto the brake disc, the control method comprising:
detecting an actual hydraulic pressure of the cylinder in an EPB disengagement; and
when the detected actual hydraulic pressure is higher than a required hydraulic pressure, controlling the EPB actuator to start an EPB disengagement control.

9. The control method of claim 8, wherein, when the detected actual hydraulic pressure is lower than the required hydraulic pressure, the starting of the EPB disengagement control comprises supplying the hydraulic pressure through an ESC actuator, until the detected actual hydraulic pressure reaches the required hydraulic pressure.

10. The control method of claim 8, wherein the starting of the EPB disengagement control comprises identifying the required hydraulic pressure according to a hydraulic pressure of the cylinder at a time of EPB engagement.

11. The control method of claim 10, further comprising:
in an EPB engagement, detecting the hydraulic pressure of the cylinder at the time of EPB engagement, and storing the detected hydraulic pressure of the cylinder in a memory.

12. The control method of claim 11, wherein the storing of the detected hydraulic pressure of the cylinder in the memory comprises storing the detected hydraulic pressure of the cylinder in the memory, when the detected hydraulic pressure of the cylinder is higher than a preset hydraulic pressure in the EPB engagement.

13. The control method of claim 11, wherein, when the detected hydraulic pressure of the cylinder is lower than a preset hydraulic pressure in the EPB engagement, the storing of the detected hydraulic pressure of the cylinder in the memory comprises supplying the hydraulic pressure through an ESC actuator, until the detected hydraulic pressure of the cylinder reaches the preset hydraulic pressure.
